(19) United States
(12) Patent Application Publication
(10) Pub. No.: US 2015/0220982 A1
(43) Pub. Date: Aug. 6, 2015

(54) BOUNDED DATA BASED TARGETED MARKETING

(71) Applicants: David DiIenno, Newfield, NJ (US); Christina Bizzari, Bear, DE (US)

(72) Inventors: David DiIenno, Newfield, NJ (US); Christina Bizzari, Bear, DE (US)

(21) Appl. No.: 14/169,629

(22) Filed: Jan. 31, 2014

(51) Int. Cl. G06Q 30/02

(52) U.S. Cl. CPC G06Q 30/0255; G06Q 30/0269; G06Q 30/0207

(57) ABSTRACT

A method and apparatus for bounded data based target marketing are disclosed. Bounded data based target marketing may include processing a bounded data set that includes a plurality of entities, wherein a first boundary condition of the bounded data set indicates that the bounded data set is associated with a provider, and a second boundary condition of the bounded data set indicates that the each entity from the plurality of entities is a customer of the provider. Bounded data based target marketing may include identifying a source entity from the plurality of entities, identifying, by a processor in response to instructions stored on a tangible non-transitory computer readable medium, a target entity from the plurality of entities on a condition that a probability that an offer from the source entity to the target entity is an acceptable offer exceeds an acceptability threshold, and indicating the offer to the target entity.

### TECHNICAL FIELD

This application relates to targeted marketing.

### BACKGROUND

Targeted marketing may include communicating information, such as an offer, regarding goods or services to potential customers based on information about the potential customers from one or more unbounded data sets. Bounded data sets, which may be special purpose data sets, may include information about the potential customers. However, targeted marketing may not include accessing and using information from bounded data sets. Therefor a method and apparatus for bounded data based targeted marketing would be advantageous.

### SUMMARY

Disclosed herein are aspects, features, elements, implementations, and embodiments of bounded data based target marketing.

Bounded data based target marketing may include processing a bounded data set, such as a bounded data set that includes a plurality of entities, wherein a first boundary condition of the bounded data set indicates that the bounded data set is associated with a provider, and a second boundary condition of the bounded data set indicates that the each entity from the plurality of entities is a customer of the provider. Bounded data based target marketing may include identifying a source entity from the plurality of entities, identifying, by a processor in response to instructions stored on a tangible non-transitory computer readable medium, a target entity from the plurality of entities on a condition that a probability that an offer from the source entity to the target entity is an acceptable offer exceeds an acceptability threshold, and indicating the offer to the target entity.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which:

FIG. 1 is a diagram of an example of a portion of a computing and communications system in which the aspects, features, and elements disclosed herein may be implemented;

FIG. 2 is a diagram of an example of a portion of a computing device in which the aspects, features, and elements disclosed herein may be implemented;

FIG. 3 is a diagram of an example of bounded data based targeted marketing in accordance with this disclosure; and

FIG. 4 is a diagram of an example of bounded data based incentives in accordance with this disclosure.

### DETAILED DESCRIPTION

The communication of information related to goods and services, particularly the communication of offers for goods and services, may be transmitted in an unfocused, or untargeted manner. However, untargeted marketing may result in relatively few completed transactions. Targeted marketing may increase the number of completed transaction per contact by limiting the communication of the information to potential customers based on relevance.

Targeted marketing may determine relevance for limiting the communication of the information to potential customers based on information about the potential customers. In particular, targeted marketing may use information obtained from general purpose, or unbounded data sets, which may include information about potential customers that is not associated with a special purpose. However, the information included in unbounded data sets may be inconstant or incomplete and targeted marketing based on unbounded data sets may be inefficient.

Bounded data sets, which may be special purpose data sets, may include information about the potential customers and may be more consistent or complete than unbounded data sets. However, bounded data sets may be unavailable for targeted marketing unrelated to the special purpose.

Bounded data based targeted marketing may include efficiently identifying and communicating with potential customers using information included in one or more bounded data sets regarding goods or services that are not directly related to the special purpose of the bounded data sets.

The aspects, features, elements, and embodiments of methods, procedures, or algorithms disclosed herein, or any part or parts thereof, may be implemented in a computer program, software, or firmware incorporated in a computer-readable storage medium for execution by a general purpose or special purpose computer or processor, and may take the form of a computer program product accessible from, such as a tangible computer-usable or computer-readable medium.

As used herein, the terminology “computer” or “computing device” includes any unit, or combination of units, capable of performing any method, or any portion or portions thereof, disclosed herein. As used herein, terminology “mobile device” or “mobile computing device” includes but is not limited to a user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such as one or more general purpose processors, one or more special purpose processors, one or more conventional processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “instructions” may include directions for performing any method, or any portion or portions thereof, disclosed herein, and may be realized in hardware, software, or any combination thereof. For example, instructions may be implemented as information stored in the memory, such as a computer program, that may be executed by a processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. Portions of the instructions may be distributed across multiple processors on the same machine or different machines or across a network such as a local area network, a wide area network, the Internet, or a combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

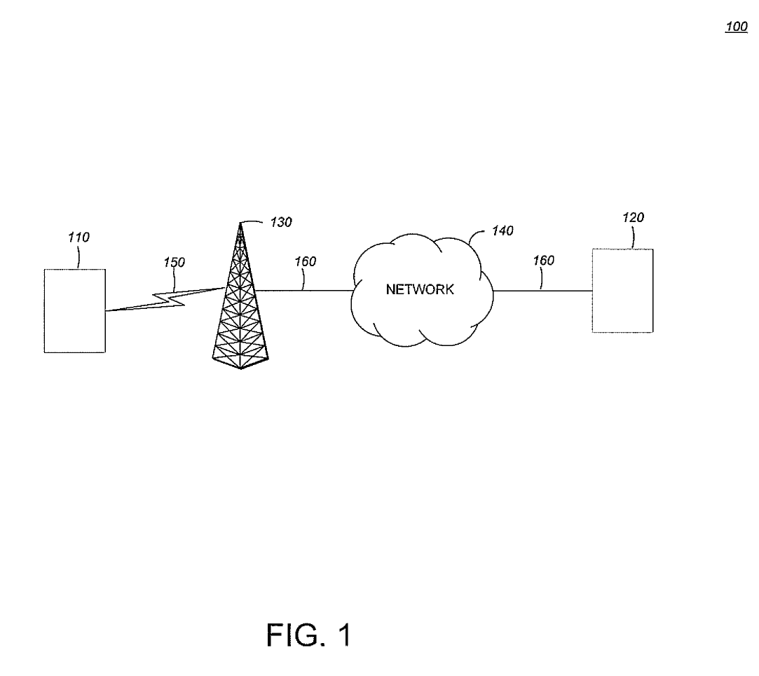

FIG. 1 is a diagram of an example of a portion of a computing and communications system 100 in which the aspects, features, and elements disclosed herein may be implemented. The computing and communications system 100 may include one or more computing devices 110/120, one or more access points 130, one or more networks 140, or a combination thereof. In some embodiments, a computing and communication system 100 may be a multiple access system and may provide for communication, such as voice communication, data communication, video communication, messaging communication, or a combination thereof, between one or more computing devices 110/120. Although, for simplicity, FIG. 1 shows two computing devices 110/120, one access point 130, and one network 140, any number of computing devices, access points, and networks may be used. In some embodiments, the computing and communications system 100 may include devices, units, or elements not shown in FIG. 1.

A computing device 110/120 may communicate via a wired communication link 150, a wireless communication link 160, or a combination of any number of wired or wireless communication links. For example, as shown, a first computing device 110 may communicate via a wireless communication link 160, and a second computing device 120 may communicate via a wired communication link 160. Although not shown in FIG. 1, a computing devices may communication directly via one or more wired or wireless communication links, such as an Ethernet link, a serial link, a Bluetooth link, an infrared (IR) link, an ultraviolet (UV) link, or any link capable of providing for electronic communication. For example, a first computing device 110 may communicate with a second computing device 120 directly and the access point 130 and the network 140 may be omitted. Although each computing device 110/120 is shown as a single unit, a computing device may include any number of interconnected elements.

An access point 130, which may include a computing device, may be configured to communicate with one or more computing devices 110/120, with a network 140, or with both via wired or wireless communication links 150/160. For example, an access point 130 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point may include any number of interconnected elements.

A network 140 may be any type of network configured to provide for voice, data, or any other type of electronic communication. For example, the network 140 may be a local area network (LAN), wide area network (WAN), virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, a network may include any number of interconnected elements.

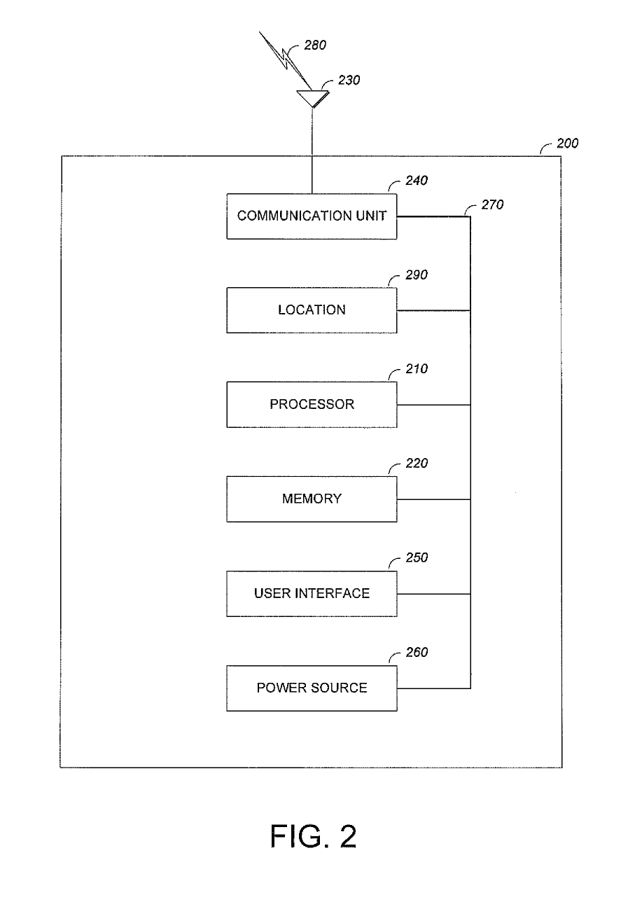

FIG. 2 is a diagram of an example of a portion of a computing device 200 in which the aspects, features, and elements disclosed herein may be implemented. A computing device 200, such as the computing devices 110/120 shown in FIG. 1, may include a processor 210, a memory 220, an electronic communication interface 230, an electronic communication unit 240, a user interface (UI) 250, a power source 260, or any combination thereof. Although shown as a single unit, any one or more element of the communication device 200 may be integrated into any number of separate physical units. For example, the UI 250 and processor 210 may be integrated in a first physical unit and the memory 220 may be integrated in a second physical unit.

In some embodiments, a computing device may include units, or elements not shown in FIG. 2, such as an enclosure, a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, or any combination thereof.

In some embodiments, the computing device 200 may be a stationary computing device, such as a personal computer (PC), a server, a workstation, a minicomputer, or a mainframe computer. In some embodiments, the computing device 200 may be a mobile computing device, such as a mobile telephone, a personal digital assistant (PDA), a laptop, or a tablet PC.

The processor 210 may include any device or combination of devices capable of manipulating or processing a signal or other information now-existing or hereafter developed, including optical processors, quantum processors, molecular processors, or a combination thereof. For example, the processor 210 may include one or more general purpose processors, one or more special purpose processors, one or more digital signal processor (DSP), one or more microprocessors, one or more controllers, one or more microcontrollers, one or more integrated circuits, one or more an Application Specific Integrated Circuits, one or more Field Programmable Gate Array, one or more programmable logic arrays, one or more programmable logic controllers, firmware, one or more state machines, or any combination thereof.

The processor 210 may be operatively coupled with the memory 220, the electronic communication interface 230, the electronic communication unit 240, the user interface (UI) 250, the power source 260, or any combination thereof. For example, the processor may be operatively couple with the memory 220 via a communication bus 270.

The memory 220 may include any tangible non-transitory computer-usable or computer-readable medium, capable of, for example, containing, storing, communicating, or transporting machine readable instructions, or any information associated therewith, for use by or in connection with the processor 210. The memory 220 may be, for example, one or more solid state drives, one or more memory cards, one or more removable media, one or more read only memories, one or more random access memories, one or more disks, including a hard disk, a floppy disk, an optical disk, a magnetic or optical card, or any type of non-transitory media suitable for storing electronic information, or any combination thereof.

The communication interface 230 may be a wireless antenna, as shown, a wired communication port, an optical communication port, or any other wired or wireless unit capable of interfacing with a wired or wireless electronic communication medium 280, such as the wireless communication link 150 or the wired communication link 160 shown in FIG. 1. Although FIG. 2 shows the communication interface 230 communicating via a single communication link, a communication interface may be configured to communicate via multiple communication links. Although FIG. 2 shows a single communication interface 230, a computing device may include any number of communication interfaces.

The communication unit 240 may be configured to transmit or receive signals via a wired or wireless medium 280. Although not explicitly shown in FIG. 1, the communication unit 240 may be configured to transmit, receive, or both via any wired or wireless communication medium, such as radio frequency (RF), ultra violet (UV), visible light, fiber optic, wire line, or a combination thereof. Although FIG. 1 shows a single communication unit 240 and a single communication interface 230, any number of communication units and any number of communication interfaces may be used.

The UI 250 may include any unit capable of interfacing with a person, such as a virtual or physical keypad, a touchpad, a display, a touch display, a speaker, a microphone, a video camera, a sensor, a printer, or any combination thereof. The UI 250 may be operatively coupled with the processor 210, as shown, or with any other element of the computing device 200, such as the power source 260. Although shown as a single unit, the UI 250 may include one or more physical units. For example, the UI 250 may include an audio interface for performing audio communication with a person, and a touch display for performing visual and touch based communication with the person.

The power source 260 may be any suitable device for powering the computing device 200. For example, the power source 260 may include a wired power source; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 200. The processor 210, the memory 220, the electronic communication interface 230, the electronic communication unit 240, the user interface (UI) 250, or any combination thereof, may be operatively coupled with the power source 260.

Although shown as separate elements, the communication interface 110, the communication unit 120, the UI 130, the processor 210, the memory 220, the electronic communication interface 230, the electronic communication unit 240, the user interface (UI) 250, or any combination thereof may be integrated in one or more electronic units, circuits, or chips.

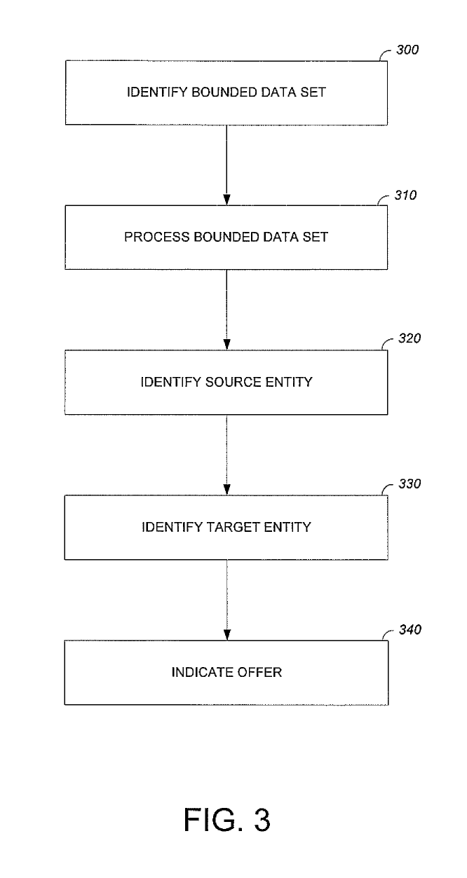

FIG. 3 is a diagram of an example of bounded data based targeted marketing in accordance with this disclosure. Bounded data based targeted marketing may be implemented in one or more computing devices, such as the computing device 200 shown in FIG. 2, communicating in a computing and communication system, such as the computing and communication system 100 shown in FIG. 1. In some embodiments, bounded data based targeted marketing may include identifying a bounded data set at 300, processing the bounded data at 310, identifying a source entity at 320, identifying a target entity at 330, indicating an offer at 340, or any combination thereof.

In some embodiments, a bounded data set may be identified at 300. Bounded data, or a bounded data set, may include any discrete set or grouping of data that is limited by one or more defined conditions independent of any logical or physical constraints on the structure of the data wherein the scope of the information represented by the bounded data is limited by a special purpose.

In some embodiments, the information represented by a bounded data set may be limited by an association with tangible goods or services, or a collection of closely related tangible goods or services. For example, a database of books published by a specific publisher may be a bounded data set and a database of all books, regardless of publisher, may be an unbounded data set. In another example, a database of members of a private club may be a bounded data set and a database of members of a public social network may be an unbounded data set.

In some embodiments, a boundary condition may indicate the special purpose that limits the scope of a bounded data set. For example, a boundary condition may indicate that the bounded data set is limited to data that is associated with a provider, such as a provider of goods or services. In some embodiments, the provider may create the bounded data set, or cause the bounded data set to be created. In some embodiments, the provider may maintain the bounded data set, or cause the bounded data set to be maintained, which may include updating the bounded data set. In some embodiments, the provider may own the bounded data set. For example, the provider may provide waste management services, and the bounded data set may include information associated with the waste management services, such as customer information, and service records.

In some embodiments, the special purpose that limits the scope of the bounded data set may be represented by a combination of boundary conditions. For example, a first boundary condition may indicate that the bounded data set is associated with a provider and a second boundary condition may indicate a relationship between the provider and entities, other than the provider, that are represented in the bounded data set. For example, the second condition may indicate that the entities are customers of the provider.

In some embodiments, a bounded data set may include information associated with one or more entities. In some embodiments, an entity may represent a person. For example, an entity may be implemented in a bounded data set as a unique identifier associated with information, such as demographic information associated with the person, transaction information associated with the person, or a combination thereof. In some embodiments, an entity may represent an organization, such as a business. For example, an entity may be implemented in a bounded data set as a unique identifier associated with information, such as organizational information associated with the organization, transaction information associated with the organization, or a combination thereof.

In some embodiments, the information associated with entities may include information elements. For example, a bounded data set may include information associated with an entity representing a person that is a customer of a provider that is an owner of the bounded data set, and the information may include information elements such as demographic information elements, which may include a name of the person, an address of the person, or any other demographic information, including statistical demographic information, associated with the person. In some embodiments, the bounded data set may include primary transaction information elements, which may indicate one or more transactions between an entity and the provider.

In some embodiments, the bounded data set may be processed at 310. In some embodiments, processing the bounded data set at 310 may include converting the bounded data set to an unbounded data set. For example, information from the bounded data set may be imported into to an unbounded data set. In another example, information from an unbounded data set my be imported into the bounded data set.

In some embodiments, processing the bounded data at 310 may include validating the bounded data set, or a portion of the bounded data set. For example, the bounded data set may include information associated with entities, such as demographic information, and validating the bounded data set may include verifying the accuracy of the information, updating the information, augmenting the information, or a combination thereof.

In some embodiments, verifying the accuracy of the information may include generating a numeric value or score representing the accuracy of the information associated with an entity. For example, the bounded data set may include multiple information elements associated with an entity, and verifying the accuracy of the information may include determining an accuracy of one or more of the information elements and generating an accuracy score based on a function of the accuracy of the validated elements, such as a sum or average. In some embodiments, the accuracy of the elements may be weighted.

In some embodiments, validating the bounded data may include identifying an entity as an invalid entity. For example, the bounded data set may include information indicating an address of an entity and validating the bounded data may include identifying information from another data set, such as an external data set or an unbounded data set, indicating an association between the entity and the address. In another example, the information from the other data set may indicate a different address associated with the entity, which may indicate that the entity is invalid or may lower the accuracy for the entity. In another example, the other data set may not include information indicating an address associated with the entity, which may indicate that the entity is invalid or may lower the accuracy for the entity.

In some embodiments, the accuracy of the information associated with an entity may be below a threshold accuracy or the difference between the accuracy of the information for an entity and a minimum accuracy may exceed an accuracy threshold, and the entity may be identified as an invalid entity. In some embodiments, identifying an entity as an invalid entity may include storing information indicating the entity as an invalid entity. For example, the information indicating the entity as an invalid entity may be stored in the bounded data set or may be stored in an auxiliary data set.

In some embodiments, validating the information may include associating information with an entity. For example, the bounded data set may include information associated with an entity, the validation may include identifying additional or alternate information associated with the entity, such as information from an external source, or statistical information generated from the bounded data, and the additional information may be stored in the bounded data set or may be stored in an auxiliary data set as information associated with the entity. In some embodiments, the information may include geolocation information, demographic information, or a combination thereof. For example, the information may include an address associated with the entity.

In some embodiments, associating information with an entity may include associating secondary transaction information with the entity. For example, the secondary transaction information may indicate a transaction, such as the purchase of goods or services, between the entity and another entity, other than the provider.

In some embodiments, a source entity, or member, may be identified at 320. In some embodiments, one or more of the entities represented in the bounded data may provide goods or services and may be identified as a source entity. For example, a customer of the provider may be identified as the source entity. In some embodiments, the source entity may be identified as an external entity, such as an entity that is not included in the bounded data set.

In some embodiments, identifying the source entity at 320 may include ignoring one or more invalid entities. For example, the bounded data set, or another data set associated with the bounded data set, may include information indicating that an entity is an invalid entity, and identifying the source entity at 320 may include omitting, excluding, or ignoring an entity associated with information indicating that the entity is invalid.

In some embodiments, identifying the source entity may include identifying an offer candidate associated with the source entity. For example, the offer candidate may indicate goods or services provided by the source entity that may be offered to one or more target entities from the bounded data set.

In some embodiments, identifying the offer may include identifying an acceptability threshold associated with the offer candidate. For example, the acceptability threshold may indicate a minimum probability that the offer from the source entity to a target entity is an acceptable offer. In some embodiments, identifying the source entity may include identifying an acceptability threshold associated with the source entity. For example, the acceptability threshold may indicate a minimum probability that any offer from the source entity to a target entity is an acceptable offer.

In some embodiments, a target entity, or user, may be identified at 330. In some embodiments, identifying a target entity may include identifying a probability that an offer from the source entity to the target entity, such as the offer identified at 320, is an acceptable offer exceeds an acceptability threshold. For example, identifying a target entity at 330 may include identifying all from the bounded data, excluding the entity identified as the source entity at 320, excluding entities identified as invalid entities at 310, identifying, for each entity, a probability that the offer is an acceptable offer, and determining whether the probability exceeds the acceptability threshold identified at 320.

In some embodiments, determining the probability that the offer is an acceptable offer for a target entity may be based on the primary transaction history information. For example, the probability may be based on the frequency of transactions in the primary transaction history information. In another example, the probability may be based on the recency of transactions in the primary transaction history information. In another example, the probability may be based on the cardinality of transactions in the primary transaction history information. In another example, the probability may be based on the size of transactions in the primary transaction history information. In another example, the probability may be based on a statistical trend indicated by transactions in the primary transaction history information, such as an increase, decrease, or pattern, in frequency, cardinality, or size of the transaction. In some embodiments, the probability may be based on a combination of metrics, which may include the frequency, recency, cardinality, size, trends, or any other information that may be included in, or generated from, the primary transaction information. In some embodiments, the primary transaction history information may include information indicating a transaction between the target entity and the provider, a transaction between the source entity and the provider, or a combination thereof.

In some embodiments, determining the probability that the offer is an acceptable offer for a target entity may be based on secondary transaction history information. For example, processing the bounded data set at 310 may include converting the bounded data set to an unbounded data set and importing secondary transaction information into the unbounded data set, and identifying the target entity at 330 may include determining the probability that the offer is an acceptable offer for a target entity may be based on secondary transaction history information. In some embodiments, determining the probability that the offer is an acceptable offer for a target entity may be based on a combination of primary transaction history information and secondary transaction history information.

In some embodiments, the offer may be indicated to the target entity at 340. For example, the offer may be indicated to the target entity via an e-mail message, a text message, such as a Simple Message Service (SMS) message, a multi-media message service (MMS) message, or an instant message (IM), a device notification, or any other communication method, or combination of communication methods capable of indicating the offer to the target entity.

In some embodiments, indicating the offer to the target entity at 340 may include indicating the offer to the source entity. In some embodiments, the offer may be indicated to the target entity in response to receiving an indication that the offer is an approved offer from the source entity. In some embodiments, indicating the offer to the source entity may include indicating a cardinality of target entities.

In some embodiments, indicating the offer to the target entity at 340 may include indicating the offer to the target entities on a condition that a cardinality of the target entities exceeds an acceptable target entity cardinality threshold. For example, identifying the source entity may include identifying an acceptable target entity cardinality threshold, which may indicate minimum number of target entities for which the probability that an offer is an acceptable offer exceeds an acceptability threshold, associated with the source entity or the offer.

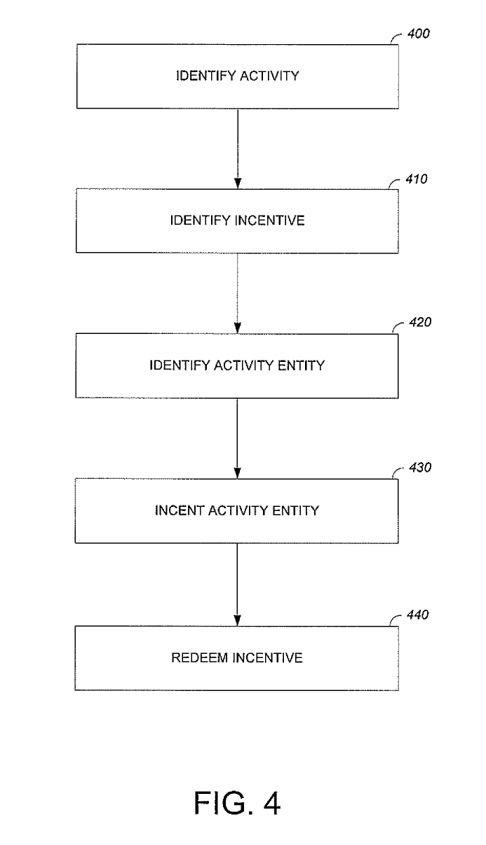

FIG. 4 is a diagram of an example of bounded data based incentives in accordance with this disclosure. Bounded data based targeted marketing, such as the bounded data based targeted marketing shown in FIG. 3, may include providing incentives. In some embodiments, providing incentives may include identifying incentive activity at 400, identifying an incentive at 410, identifying an activity entity at 420, incentivizing the target entity at 430, redeeming incentives at 440, or a combination thereof.

In some embodiments, an incentive activity may be identified at 400. Identifying an incentive activity may include identifying a defined activity, such as an activity initiated by an entity, such as a member or a user. For example, a referral may be an incentive activity, a converted referral may be an incentive activity, a redemption, or acceptance, of an offer may be an incentive activity, an interface interaction, such as viewing an offer, may be an incentive activity, sharing an offer may be an incentive activity, sharing of a member by a user to another user may be an incentive activity, or any other activity that may be incentivized may be an incentive activity. In some embodiments, activities may be performed using an application, which may include a user interface implemented in a device, such as the device 200 shown in FIG. 2. For example, a target entity, such as a user, may view an offer using a user interface implemented on a smartphone.

In some embodiments, an incentive may be identified at 410. Identifying an incentive may include identifying an activity worth, such as a number of points or a digital currency amount, associated with the activity. In some embodiments, an activity may be associated with a default worth. For example, viewing an offer may be associated with a defined worth. In some embodiments, an activity may be associated with an entity-default worth. For example, viewing an offer from a first source entity may be associated with a first default worth associated with viewing an offer from the first source entity, and viewing an offer from a second source entity may be associated with a second default worth associated with viewing an offer from the second source entity. In some embodiments, an activity may be associated with an activity specific worth. For example, an entity, such as the provider, or a source entity, may a specified activity, such as viewing a specific offer, is associated with a specified worth, which may be different from a default worth associated with the activity. Although activity worth is described herein as a digital currency, an activity worth may be implemented as information that may be associated with a currency amount. For example, an activity worth may be implemented as a redeemable discount, goods, or services associated with a specified amount of the digital currency.

In some embodiments, an activity entity may be identified at 420. Identifying an activity entity may include identifying entities associated with the activity identified at 400, such as a target entity or a source entity. For example, a first target entity, or user, may refer a source entity, such as a member, to a second target entity, and the first target entity, the second target entity, and the source entity may be identified as activity entities.

In some embodiments, the activity entity may be incentivized at 430. Incentivizing the activity entity may include associating the activity worth identified at 410 with one or more of the activity entities identified at 420. For example, an entity, such as a target entity or a source entity, may accumulate digital currency and the activity worth may be added to the activity entities accumulation of digital currency. In some embodiments, incentives, such as digital currency, may be accumulated in a digital wallet associated with the entity.

In some embodiments, incentives may be redeemed at 440. In some embodiments, redeeming incentives may include transferring an incentive, or a portion thereof, such as an amount of digital currency, from one entity to another. In some embodiments, redeeming incentives may include exchanging an incentive, or a portion thereof, such as an amount of a digital currency, for goods or services. For example, a target entity may redeem an incentive, or a portion thereof, with a source entity by exchanging the incentive for goods or services. In some embodiments, redeeming an incentive may be performed using, for example, a user interface implemented in a device, such as the device 200 shown in FIG. 2.

In some embodiments, redeeming an incentive may include performing a hardware supported transaction. For example, a device, such as the device 200 shown in FIG. 2, may include a hardware supported transaction unit, such as a near field communications (NFC) unit, and the NFC unit may be used to redeem an incentive. In some embodiments, the hardware supported transaction unit may be used to process transactions, such as transaction for the purchase of goods or services, using one or more payment methods, or combinations of payment methods, such as incentives, credit cards, debit cards, or bank transfers.

The above-described aspects, examples, and implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
processing a bounded data set that includes a plurality of entities, wherein a first boundary condition of the bounded data set indicates that the bounded data set is associated with a provider, and a second boundary condition of the bounded data set indicates that the each entity from the plurality of entities is a customer of the provider;
identifying a source entity from the plurality of entities;
identifying, by a processor in response to instructions stored on a tangible non-transitory computer readable medium, a target entity from the plurality of entities on a condition that a probability that an offer from the source entity to the target entity is an acceptable offer exceeds an acceptability threshold; and
indicating the offer to the target entity.

2. The method of claim 1, wherein processing the bounded data set includes validating the plurality of entities.

3. The method of claim 2, wherein, for an entity from the plurality of entities, the validating includes:
determining an accuracy of information associated with the entity; and
on a condition that a difference between the accuracy and a minimum accuracy exceeds an accuracy threshold, identifying the entity as an invalid entity, wherein identifying the source entity from the plurality of entities includes ignoring invalid entities and wherein identifying the target entity from the plurality of entities includes ignoring invalid entities.

4. The method of claim 2, wherein, for an entity from the plurality of entities, the validating includes associating information with the entity, wherein the information includes geolocation information or demographic information.

5. The method of claim 1, wherein identifying the target entity includes:
determining the probability that the offer from the source entity to the target entity is an acceptable offer based on primary transaction history information.

6. The method of claim 5, wherein the primary transaction history information indicates a transaction between the target entity and the provider, a transaction between the source entity and the provider, or a transaction between the target entity and the provider and a transaction between the source entity and the provider.

7. The method of claim 1, wherein processing the bounded data set includes importing information from the bounded data set to an unbounded data set.

8. The method of claim 7, wherein, for an entity from the plurality of entities, the validating includes associating information with the entity, wherein the information includes secondary transaction history information.

9. The method of claim 8, wherein the secondary transaction history information indicates a transaction between the entity and another entity from the plurality of entities.

10. The method of claim 9, wherein identifying the target entity includes:
determining the probability that the offer from the source entity to the target entity is an acceptable offer based on the secondary transaction history information.

11. The method of claim 9, wherein identifying the target entity includes:
determining the probability that the offer from the source entity to the target entity is an acceptable offer based on a combination of primary transaction history information and the secondary transaction history information.

12. The method of claim 11, wherein the primary transaction history information indicates a transaction between the target entity and the provider, a transaction between the source entity and the provider, or a transaction between the target entity and the provider and a transaction between the source entity and the provider.

13. The method of claim 7, wherein the identifying the target entity includes identifying the acceptability threshold based on the source entity.

14. The method of claim 1, wherein indicating the offer to the target entity includes:
indicating the offer to the source entity; and
indicating the offer to the target entity in response to receiving an indication that the offer is an approved offer from the source entity.

15. The method of claim 1, wherein identifying the target entity includes identifying a plurality of target entities from the plurality of entities.

16. The method of claim 15, wherein indicating the offer to the target entity includes:
indicating the offer to the source entity;
indicating a cardinality of the plurality of target entities to the source entity; and
indicating the offer to each target entity in the plurality of target entities in response to receiving an indication that the offer is an approved offer from the source entity.

17. The method of claim 15, wherein indicating the offer to the target entity includes:
indicating the offer to each target entity in the plurality of target entities on a condition that a cardinality of the plurality of target entities exceeds a cardinality threshold.

18. The method of claim 1, further comprising:
identifying an activity in response to indicating the offer to the target entity;
identifying an incentive associated with the activity;
associating the incentive with the target entity; and
redeeming the incentive.

19. The method of claim 1, wherein redeeming the incentive includes transferring at least a portion of the incentive from the target entity to the source entity.

20. A method comprising:
processing a bounded data set that includes a plurality of entities, wherein a first boundary condition of the bounded data set indicates that the bounded data set is associated with a provider, and a second boundary condition of the bounded data set indicates that the each entity from the plurality of entities is a customer of the provider;
converting the bounded data set to an unbounded data set;
identifying a source entity from the plurality of entities;
identifying, by a processor in response to instructions stored on a tangible non-transitory computer readable medium, a target entity from the plurality of entities;
generating an offer indicator indicating an offer from the source entity to the target entity;
determining a probability that the offer is an acceptable offer based on primary transaction history information, wherein the primary transaction history information indicates a transaction between the target entity and the provider or a transaction between the source entity and the provider; and
indicating the offer to the target entity on a condition that the probability exceeds an acceptability threshold.
